(19) United States
(12) Patent Application Publication
(10) Pub. No.: US 2025/0148937 A1
(43) Pub. Date: May 8, 2025

(54) Labels with Adhesive Patch Patterns Optimized for Printer Applications

(71) Applicant: Iconex LLC, Duluth, GA (US)

(72) Inventors: James Kirby Price, Morristown, TN (US); Michael Bejon Sethna, Jefferson City, TN (US)

(21) Appl. No.: 18/670,109

(22) Filed: May 21, 2024

Related U.S. Application Data
(63) Continuation-in-part of application No. 18/504,959, filed on Nov. 8, 2023.

(51) Int. Cl. G09F 3/02; G09F 3/10

(52) U.S. Cl. CPC G09F 3/02; G09F 3/10; G09F 2003/0229; G09F 2003/023

(57) ABSTRACT

Linerless labels with adhesive patches arranged in optimal adhesive patch patterns are provided. The adhesive patch patterns mitigate adhesive buildup on components of a printer when a roll of linerless labels is fed through a printer by minimizing the adhesive coverage area on the backside of the linerless labels without altering the adhesive bonding characteristics of the individual linerless labels dispensed from the printer. The adhesive is a microsphere adhesive having a particle size between 10-250 or 20-350 microns. In an embodiment, the microsphere adhesive includes solids of at least 25% in the microsphere adhesive.

### RELATED APPLICATIONS

This application is a continuation-in part (CIP) of co-pending U.S. applicant Ser. No. 18/504,959, filed Nov. 8, 2023, entitled “Labels with Adhesive Patch Patterns Optimized for Printer Applications,” the disclosure of which is incorporated herein in its entirety.

### BACKGROUND

Labels are used for a variety of purposes across multiple industries. Furthermore, labels have a variety of capabilities based on their intended applications. Many label capabilities are dependent upon a variety of adhesive-based factors, such as adhesive type, adhesive pattern, adhesive patch shapes, adhesive flood coat, mixtures of adhesives, and adhesive activation mechanism (e.g., pressure, heat, etc.). Capabilities that require a high tack are often achieved through using an aggressive adhesive.

A label with an aggressive adhesive sticks to or accumulates on components of a printer as a roll of labels are imaged/printed by the printer. That is, labels with aggressive adhesives cause printer jams or printer malfunctions with greater regularity than do labels with less aggressive adhesives.

### SUMMARY

In various embodiments, linerless labels with adhesive patch patterns, which are optimized to reduce adhesive buildup on printer components, and a method for manufacturing the labels with the patch patterns are provided. In an embodiment, a linerless label is provided. In an embodiment, the adhesive of the adhesive patches include acrylic emulsion having microspheres with particle sizes in an approximate rage of 10-250 microns. In an embodiment, the solid materials present in the adhesive of the adhesive patch is approximately greater than 25%. In an embodiment, the adhesive coverage area of the adhesive is approximately 80% of a total coverage area of the adhesive patch itself. In an embodiment, the adhesive patches in a given adhesive patch pattern has a coverage area of between 30% to 70% of a total surface area of the backside of a given label.

### BRIEF DESCRIPTION OF THE DRAWINGS

FIG. 1 is a diagram of a linerless label with an adhesive patch pattern optimized for printer applications, according to an example embodiment.

FIG. 2 is a diagram of another linerless label in a roll of labels, each label with an adhesive patch pattern optimized for printer applications, according to an example embodiment.

FIG. 3 is a diagram of still another linerless label in a roll of labels, each label with an adhesive patch pattern optimized for printer applications, according to an example embodiment.

FIG. 4 is a diagram of yet another linerless label in a roll of labels, each label with an adhesive patch pattern optimized for printer applications, according to an example embodiment.

FIG. 5 is a diagram of a linerless label in a roll of labels, each label with an adhesive patch pattern optimized for printer applications, according to an example embodiment.

FIG. 6 is a diagram of another linerless label in a roll of labels, each label with an adhesive patch pattern optimized for printer applications, according to an example embodiment.

FIG. 7 is a diagram of a linerless label in a roll of labels with an adhesive patch pattern optimized for printer applications, according to an example embodiment.

FIG. 8 is yet another diagram of a linerless label in a roll of labels with an adhesive patch pattern optimized for printer applications, according to an example embodiment.

FIG. 9 is still another diagram of a linerless label in a roll of labels with an adhesive patch pattern optimized for printer applications, according to an example embodiment.

FIG. 10 is a diagram of a linerless label in a roll of labels, each label with an adhesive patch pattern optimized for printer applications, according to an example embodiment.

FIG. 11 is a diagram of yet another linerless label in a roll of labels, each label with an adhesive patch pattern optimized for printer applications, according to an example embodiment.

FIG. 12 is a diagram of a linerless label with an adhesive patch pattern optimized for printer applications, according to an example embodiment.

FIG. 13 is a diagram of a linerless label with an adhesive patch pattern optimized for printer applications, according to an example embodiment.

FIG. 14 is a diagram of a linerless label with an adhesive patch pattern optimized for printer applications, according to an example embodiment.

FIG. 15 is a diagram of a linerless label with an adhesive patch pattern optimized for printer applications, according to an example embodiment.

FIG. 16 is a diagram of a linerless label with an adhesive patch pattern optimized for printer applications, according to an example embodiment.

FIG. 17 is a diagram of a linerless label with an adhesive patch pattern optimized for printer applications, according to an example embodiment.

FIG. 18 is a diagram of a linerless label with an adhesive patch pattern optimized for printer applications, according to an example embodiment.

FIG. 19 is a diagram of a linerless label with an adhesive patch pattern optimized for printer applications, according to an example embodiment.

FIG. 20 is a diagram of a linerless label with an adhesive patch pattern optimized for printer applications, according to an example embodiment.

FIG. 21 is a diagram of a method for manufacturing a roll of linerless labels, each label with an adhesive patch pattern optimized for printer applications, according to an example embodiment.

### DETAILED DESCRIPTION

As stated above, aggressive adhesives present difficulties for printer-based label applications because the adhesive sticks to or accumulates on components of the printer as a roll of labels is fed through the printer. Many retailers print labels for orders or transactions from printers. The labels are then adhered to the packaging of the orders, when the packaging necessitates use of a label with an aggressive adhesive, the retailer has to produce a solution. Presently, the options available to a retailer is either to request changes in the packaging material and/or request the label stock be changed to a more expensive and stiffer paper. Both options are likely to increase the retailer's costs.

In addition, characteristics of the adhesive used dictate whether the label is repositionable or removable from an object that the label is adhered to and re-adhered to a different location on the object or a different object. Repositionable adhesive, when properly formulated and patterned within adhesive patches, can provide both a sufficient enough aggressive adhesive while also allowing a given label to be removed from an object or surface and reused.

These issues are solved with the linerless labels and rolls of linerless labels provided herein. The linerless labels and rolls include optimized adhesive patches disposed in optimized patterns on the backside with a repositionable adhesive used in the optimized adhesive patches of the linerless labels. The adhesive patch patterns and adhesive formulation provide characteristics for sufficient high tack and aggressive adhesives and provide characteristics for repositionable adhesives on the labels while at the same time mitigating printer adhesive buildup, jams, and other printer malfunctions caused by adhesive buildup on the printer components.

The shapes, sizes, orientations, and location of the adhesive patch patterns on the backside of the linerless labels along with the adhesive formulation of the adhesive used for the adhesive patches ensure minimal contact with printer components when a roll of the labels are fed through the printer. Furthermore, the shapes, sizes, orientations, and location of the adhesive patch patterns on the backside of the linerless labels along with the adhesive formulation of the adhesive used for the adhesive patches do not decrease the stickiness nor decrease adhesive bonding capabilities of the linerless labels after the linerless labels are dispensed from the printer and adhered to objects, packages, and/or surfaces, and subsequently removed from the objects/packages/surfaces and re-adhered to other locations on the same objects/packages/surfaces or subsequently re-adhered to different objects/packages/surfaces. The linerless labels with the adhesive patches in the optimized patterns with the adhesive formulation permit sufficient aggressive adhesive characteristics to be exhibited in rolls of linerless labels without the rolls causing adverse printer malfunctions.

In an embodiment, the labels presented herein and below with the adhesive patches disposed on the backside of the labels in the optimized adhesive patterns are linerless labels. The pattern repeats for a roll of the labels along the backside of the substrate associated with the roll.

As used herein, an “adhesive patch” includes one or more continuous areas of adhesive and one or more discontinuous areas of adhesive disposed on the backside of a roll of labels. The discontinuous areas of adhesive are associated with areas that are adhesive free or devoid of any adhesive material. Thus, the adhesive patch is disposed in an adhesive pattern on the backside of a roll or labels or on a backside of a single label.

In an embodiment, a front side of the label substrate associated with the linerless labels includes a thermally activated and sensitive image coating. A thermal printer selectively applies heat to the coating on the front side to image custom indicia, symbols, and/or graphics on the front side of each linerless label. In an embodiment, the thermally activated and sensitive image coating further includes a release coating applied atop the thermally activated and sensitive image coating, which permits a sheet of the linerless labels to be wound into a roll, the roll fed to the thermal printer, the roll unwound by the thermal printer, the front sides of the labels imaged/printed by the thermal printer, and individual printed/imaged labels cut and dispensed by the thermal printer.

In an embodiment, the release coating is a non-silicone, or a substantially non-silicone release coating optimized to reduce printer jams and wraps. In an embodiment, the release coating is a water-based release coating. In an embodiment, the release coating is a silicone-based release coating.

In an embodiment, the label substrate is a paper-based material or paper. In an embodiment, the label substrate is a film. In an embodiment, the label substrate has an approximate paper stock weight of greater than or equal to 50 gsm (grams per square meter).

As used herein, the phrases “optimized adhesive patches” and/or “optimized adhesive patch patterns” can be used interchangeably and synonymously herein and below. This is intended to mean that the size, shape, placement, orientation, location, and coverage area of the adhesive associated with a given patch and pattern are designed to minimize adhesive buildup on components of printers when a roll of the labels is fed through a printer without decreasing the adhesive bonding characteristics of the labels dispensed from the printers.

The adhesive formulation used in the optimized adhesive patches and optimized adhesive patch patterns permits the labels to be repositionable. That is, the adhesive formulation is repositionable and/or semi permanent, which enhances recyclability and enhances functionality of the label by enabling the label to be removed and reapplied to support multiple applications of the label to objects/packages/surfaces.

As used herein, the phrases “linerless label” and “liner-free label” can be used interchangeably or synonymously. This refers to a label and/or a roll of labels manufactured from a single substrate or label substrate.

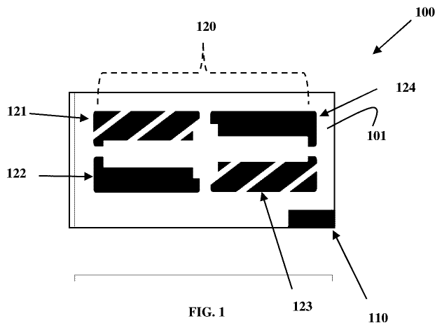

FIG. 1 is a diagram of a linerless label 100 with an adhesive patch pattern 120 optimized for printer applications, according to an example embodiment. A backside 101 of a label substrate for the label 100 is illustrated in FIG. 1.

The darkened areas (except for 110) represent the adhesive disposed on the backside 101 in the illustrated pattern 120. In an embodiment, a sense mark 110 is printed or imaged in a bottom corner of the backside 101. The sense mark 110 delineates the label 100 from other labels 100 in a roll. The sense marks 110 are read by a printer to identify each individual label 100 within the roll when the roll is fed into the printer for imaging/printing the labels 100 from the roll. In an embodiment, the label 100 includes no sense marks.

The coverage area of the adhesive patches defined by the adhesive pattern 120 is less than a remaining surface area of the backside 101 defined by the white areas and the optional sense mark 110 in FIG. 1. In an embodiment, the adhesive coverage area of the adhesive patch pattern is approximately 30.10% of a total surface area associated with the backside 101 of the label substrate.

The adhesive pattern 120 includes a first adhesive patch 121, a second adhesive patch 123, a third adhesive patch 122, and a fourth adhesive patch 124. None of the adhesive patches 121-124 intersect with one another. The first adhesive patch 121 and the second adhesive patch 123 are of a same first shape. The third adhesive patch 122 and the fourth adhesive patch 124 are of a same second shape.

The first adhesive patch 121 is diagonally situated on the backside 101 relative to the second adhesive patch 123. Similarly, the third adhesive patch 122 is diagonally situated on the backside 101 relative to the fourth adhesive patch 124. The first adhesive patch 121 is situated above the third adhesive patch 122 and the fourth adhesive patch 124 is situated above the second adhesive patch 123. The horizontal and vertical orientation of the second adhesive patch 123 is flipped/reversed relative to the horizontal and vertical orientation of the first adhesive patch 121. Similarly, the horizontal and vertical orientation of the fourth adhesive patch 124 is flipped/reversed relative to the horizontal and vertical orientation of the third adhesive patch 122.

The first shape associated with the first adhesive patch 121 and the second adhesive patch 123 is similar to but not identical to the second shape associated with the third adhesive patch 122 and the fourth adhesive patch 124. Notably, the first shape include diagonal cutout lines which are devoid of adhesive, and the height of the first shape is larger than the height of the second shape. Both shapes include a rectangular portion and two extending rectangular bars. The orientation of the shapes are such that the extending rectangular bars of each adhesive patch are pointing at an adjacent adhesive patch's extending rectangular bars.

In an embodiment, the first shape associated with the first adhesive patch 121 and the second adhesive patch 123 include three diagonal bars that are cutout and devoid of any adhesive. In an embodiment, a first offset between a top side of the label 100 and a top of the first adhesive patch 121 and the fourth adhesive patch is smaller than a second offset between a bottom side of the label 100 and a bottom of the third adhesive patch 122 and the second adhesive patch 123.

In an embodiment, a plurality of labels 100 are defined within a roll of labels, each label separated by an imaged/printed sense mark 110. The roll is inserted into an infeed of a printer and fed to the printer. The printer images/prints custom indicia, graphics, symbols, etc. on each label 100, cuts each label 100 from the roll, and dispenses each label 100 for application to packaging, an object, or a surface. When the roll is fed through the printer, the coverage area of the adhesive on the backside 101 defined by the pattern 120, and the size, location, and orientations of adhesive patches 121-124 for the adhesive patch minimize adhesive contact with printer components. This minimizes adhesive buildup and printer jams/malfunctions. Furthermore, the coverage area of the adhesive on the backside defined by the pattern 120, and the size, location, and orientations of the adhesive patches 121-124 do not decrease the labels' adhesive bonding characteristics once the labels 100 are dispensed individually from the printer.

In an embodiment, a repositionable and microsphere adhesive is used for the adhesive patch identified by pattern 120 and adhesive patches 121-124. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 120 is between 30% and 70% of a total surface area of the backside of the label 100.

In an embodiment, a front side of the label 100 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label includes a stock weight of greater than or equal to 50 gsm.

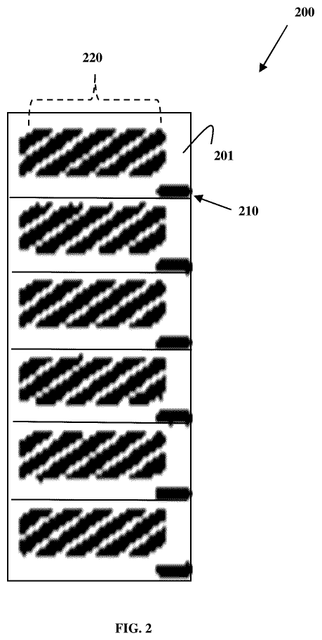

FIG. 2 is a diagram of another linerless label 200 in a roll, each label 200 includes an adhesive patch pattern 220, which is optimized for printer applications, according to an example embodiment. Again, a backside for each label 200 in the roll is illustrated in FIG. 2.

The backside 201 includes adhesive patch(es) illustrated by the darkened areas (except not 210), which are arranged in an adhesive patch pattern 220. Each label 200 within the roll further includes an optional printed/imaged sense mark 210, which is read by a printer to delineate and to identify each label 200 within the roll.

The adhesive patch pattern 220 includes diagonally oriented adhesive patches, which do not intersect with one another on the backside 201 of each label 200. Between each adhesive patch is a bar shaped area, which is devoid of any adhesive. A few of the adhesive patches are of a same size while other of the adhesive patches are of varied sizes.

The coverage area, shape, size, orientation, and placement of the adhesive patches within the pattern 220 of the adhesive patch are optimized to minimize contact with printer components when the roll of the labels 200 are fed through the printer. However, the coverage area, shape, size, orientation, and placement of the adhesive patches within the pattern 220 of the adhesive patch for each dispensed label 200 from the printer maintains the adhesive bonding characteristics for the type of the adhesive used to still stick and adhered the label 200 to package materials, objects, and surfaces.

In an embodiment, a repositionable and microsphere adhesive is used for the adhesive patch identified by pattern 220. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 220 is between 30% and 70% of a total surface area of the backside of the label 200.

In an embodiment, a front side of the label 200 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 200 includes a stock weight of greater than or equal to 50 gsm.

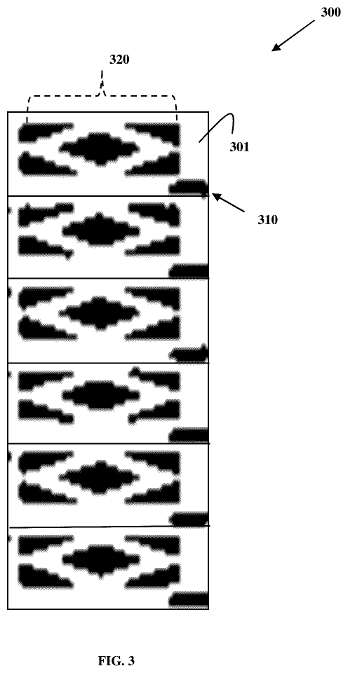

FIG. 3 is a diagram of still another linerless label 300 in a roll, each label 200 includes an adhesive patch pattern 320, which is optimized for printer applications, according to an example embodiment. A backside 301 for each label 300 in the roll is illustrated in FIG. 3.

The backside 301 includes an adhesive patch illustrated by the darkened areas (except not 310), which are arranged in an adhesive patch pattern 320. Each label 300 within the roll further includes an optional printed/imaged sense mark 310, which is read by a printer to delineate and to identify each label 300 within the roll.

The adhesive patch pattern 320 includes 5 adhesive patches, which do not intersect with one another on the backside 301 of each label 300. Between each adhesive patch is an area, which is devoid of any adhesive. Four of the adhesive patches are of a same size one of the adhesive patches is larger than the other four adhesive patches. The largest adhesive patch is substantially centered on the backside 301 and is in a diamond shape. The four other adhesive patches are each adjacent to a unique corner of the backside 301 and each triangular in shape. A non-adhesive area separates the sides or perimeter of the backside 301 and the four corner adhesive patches. A diamond-shaped non-adhesive area surrounds the center diamond shaped component. The diamond-shaped non-adhesive area is larger than the center diamond shaped component.

The coverage area, shape, size, orientation, and placement of the five adhesive patches within the pattern 320 of the adhesive patch are optimized to minimize contact with printer components when the roll of the labels 300 are fed through the printer. However, the coverage area, shape, size, orientation, and placement of the five adhesive patches within the pattern 320 of the adhesive patch for each dispensed label 300 from the printer maintains the adhesive bonding characteristics for the type of the adhesive used to still stick and adhered the label 300 to package materials, objects, and surfaces.

In an embodiment, a repositionable and microsphere adhesive is used for the adhesive patch identified by pattern 320. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 320 is between 30% and 70% of a total surface area of the backside of the label 300.

In an embodiment, a front side of the label 300 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 300 includes a stock weight of greater than or equal to 50 gsm.

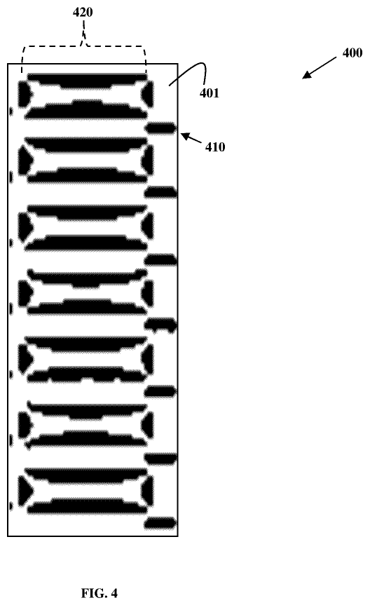

FIG. 4 is a diagram of yet another linerless label 400 in a roll, each label 400 includes an adhesive patch pattern 420, which is optimized for printer applications, according to an example embodiment. A backside 401 for each label 400 in the roll is illustrated in FIG. 4.

The backside 401 includes an adhesive patch illustrated by the darkened areas (except not 410), which are arranged in an adhesive patch pattern 420. Each label 400 within the roll further includes an optional printed/imaged sense mark 410, which is read by a printer to delineate and to identify each label 400 within the roll.

The adhesive patch pattern 420 includes 4 adhesive patches, which do not intersect with one another on the backside 401 of each label 400. Between each adhesive patch is an area, which is devoid of any adhesive. A first set of two of the adhesive patches is of a same first size while a second set of two of the adhesive patches is of a same second size; the second size is larger than the first size. The first set of adhesive patches is adjacent to a right or left side of the label 400. The second set of adhesive patches is adjacent to a top or bottom side of the label 400. The arrangement of the first and second sets define a large center area portion that is devoid of any adhesive and shaped similar to a rectangle having a concave half circle top and bottom and an elongated concave half circle right side and left side. Both the first set of adhesive patches and the second set of adhesive patches are of a similar shape; however, the second set of adhesive patches is longer and wider than the first set of adhesive patches. The similar shapes are of a half circle stretched out from top to bottom and from left to right. One side of each of the 4 adhesive patches is straight while an opposing side of each of the 4 adhesive patches is a half-circle extending or oriented towards a center of the label 400.

The coverage area, shape, size, orientation, and placement of the four adhesive patches within the pattern 420 of the adhesive patch are optimized to minimize contact with printer components when the roll of the labels 400 are fed through the printer. However, the coverage area, shape, size, orientation, and placement of the 4 adhesive patches within the pattern 420 of the adhesive patch for each dispensed label 400 from the printer maintains the adhesive bonding characteristics for the type of the adhesive used to still stick and adhered the label 400 to package materials, objects, and surfaces.

In an embodiment, a repositionable and microsphere adhesive is used for the adhesive patch identified by pattern 420. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 420 is between 30% and 70% of a total surface area of the backside of the label 400.

In an embodiment, a front side of the label 400 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 400 includes a stock weight of greater than or equal to 50 gsm.

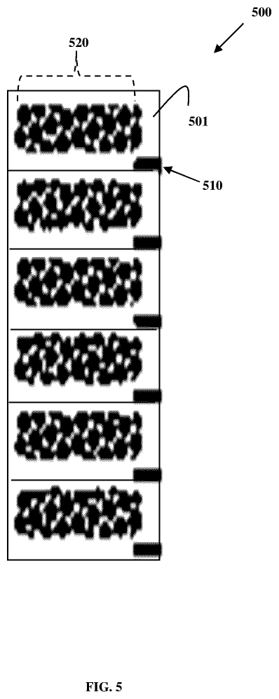

FIG. 5 is a diagram of a linerless label 500 in a roll, each label 500 includes an adhesive patch pattern 520, which is optimized for printer applications, according to an example embodiment. A backside 501 for each label 500 in the roll is illustrated in FIG. 5.

The backside 501 includes an adhesive patch illustrated by the darkened areas (except not 510), which are arranged in an adhesive patch pattern 520. Each label 500 within the roll further includes an optional printed/imaged sense mark 510, which is read by a printer to delineate and to identify each label 500 within the roll.

The adhesive patch pattern 520 includes a plurality of adhesive patches, which do not intersect with one another on the backside 501 of each label 500. Between each adhesive patch is an area, which is devoid of any adhesive. The adhesive patches are spaced and offset from the sides of the label 500 defining a perimeter along the backside 501 which is devoid of any adhesive. In an embodiment, each of the adhesive patches is in a same circular shape. In an embodiment, each of the adhesive patches is in a same bar or rectangular shape.

The coverage area, shape, size, orientation, and placement of the adhesive patches within the pattern 520 of the adhesive patch are optimized to minimize contact with printer components when the roll of the labels 500 are fed through the printer. However, the coverage area, shape, size, orientation, and placement of the adhesive patches within the pattern 520 of the adhesive patch for each dispensed label 500 from the printer maintains the adhesive bonding characteristics for the type of the adhesive used to still stick and adhered the label 500 to package materials, objects, and surfaces.

In an embodiment, a repositionable and microsphere adhesive is used for the adhesive patch identified by pattern 520. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 520 is between 30% and 70% of a total surface area of the backside of the label 500.

In an embodiment, a front side of the label 500 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 500 includes a stock weight of greater than or equal to 50 gsm.

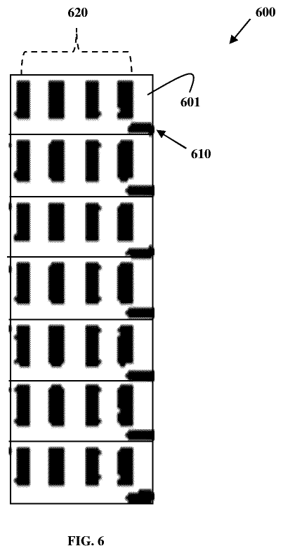

FIG. 6 is a diagram of another linerless label 600 in a roll, each label 600 includes an adhesive patch pattern 620, which is optimized for printer applications, according to an example embodiment. A backside 601 for each label 600 in the roll is illustrated in FIG. 6.

The backside 601 includes an adhesive patch illustrated by the darkened areas (except not 610), which are arranged in an adhesive patch pattern 620. Each label 600 within the roll further includes an optional printed/imaged sense mark 610, which is read by a printer to delineate and to identify each label 600 within the roll.

The adhesive patch pattern 620 includes 4 adhesive patches, which do not intersect with one another on the backside 601 of each label 600. Between each adhesive patch is an area, which is devoid of any adhesive. The adhesive patches are evenly spaced apart from one another along the backside 601 and each adhesive patch is offset from a top and a bottom of label 600. Each of the adhesive patches is of a rectangular bar shape that extends from an offset along a top of the label 600 to an offset along a bottom of the label 600. Two of the 4 adhesive patches are adjacent to a right side or left side of the label 600, and two of the 4 adhesive patches adjacent to a top of the label 600, a bottom of the label 600, and two other adhesive patches on a right and a left.

The coverage area, shape, size, orientation, and placement of the four adhesive patches within the pattern 620 of the adhesive patch are optimized to minimize contact with printer components when the roll of the labels 600 are fed through the printer. However, the coverage area, shape, size, orientation, and placement of the 4 adhesive patches within the pattern 620 of the adhesive patch for each dispensed label 600 from the printer maintains the adhesive bonding characteristics for the type of the adhesive used to still stick and adhered the label 600 to package materials, objects, and surfaces.

In an embodiment, a repositionable and microsphere adhesive is used for the adhesive patch identified by pattern 620. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 620 is between 30% and 70% of a total surface area of the backside of the label 600.

In an embodiment, a front side of the label 600 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 600 includes a stock weight of greater than or equal to 50 gsm.

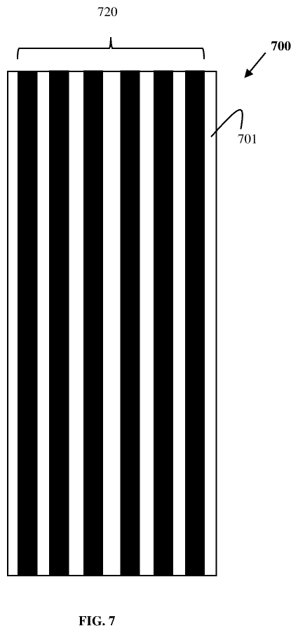

FIG. 7 is a diagram of linerless labels 700 in a roll of labels with an adhesive patch pattern optimized for printer applications, according to an example embodiment. A backside 701 for each label 700 in the roll is illustrated in FIG. 7.

The backside 701 includes an adhesive patch(es) illustrated by the darkened areas and arranged in an adhesive patch pattern 720. Each label 700 within the roll further includes an optional printed/imaged sense mark (not shown in FIG. 7), which is read by a printer when present to delineate and to identify each label 600 within the roll.

In an embodiment, the adhesive patch pattern 720 includes greater than 4 adhesive patches, which do not intersect with one another on the backside 701 of each label 700. The adhesive patches are vertically striped down the backside 701 and are continuous throughout the roll. The patches do not intersect one another and are separated by vertical areas that are devoid of adhesive.

In an embodiment, the adhesive patch pattern 720 include greater than 5 adhesive patches, which do not intersect one another on the backside 701 of each label 700. The adhesive patches are vertically striped down the backside 701 and are continuous throughout the roll. The patches do not intersect one another and are separated by vertical areas that are devoid of adhesive.

In an embodiment, the adhesive patch pattern 720 includes 4 adhesive patches, which do not intersect one another on the backside 701 of each label 700. The adhesive patches are vertically striped down the backside 701 and are continuous throughout the roll. The patches do not intersect one another and are separated by vertical areas that are devoid of adhesive.

In an embodiment, the adhesive patches are evenly spaced apart from one another along the backside 701. In an embodiment, the adhesive patches are unevenly spaced apart from one another along the backside 701.

In an embodiment, side-adjacent adhesive patches are offset from a corresponding side of the roll. In an embodiment, each adhesive patch is offset from a top and a bottom of the roll. In an embodiment, side-adjacent adhesive patches extend to the side with no adhesive-free area separating a corresponding adhesive patch from a side of the roll. In an embodiment, tops and bottoms of each adhesive patch extend to the top and bottom of the roll with no offset and not intervening adhesive free area.

The coverage area, shape, size, orientation, and placement of the adhesive patches within the pattern 720 of the adhesive patches are optimized to minimize contact with printer components when the roll of the labels 700 are fed through the printer. However, the coverage area, shape, size, orientation, and placement of the adhesive patches within the pattern 720 of the adhesive patch for each dispensed label 700 from the printer maintains the adhesive bonding characteristics for the type of the adhesive used to still stick and adhered the label 700 to package materials, objects, and surfaces.

In an embodiment, a repositionable and microsphere adhesive is used for the adhesive patches identified by pattern 720. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 720 is between 30% and 70% of a total surface area of the backside of the label 700.

In an embodiment, a front side of the label 700 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 700 includes a stock weight of greater than or equal to 50 gsm.

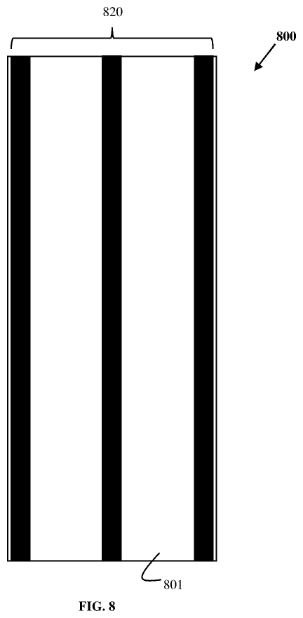

FIG. 8 is yet another diagram of linerless labels 800 in a roll of labels with an adhesive patch pattern 820 optimized for printer applications, according to an example embodiment. A backside 801 for each label 700 in the roll is illustrated in FIG. 8.

The backside 801 includes an adhesive patch(es) illustrated by the darkened areas and arranged in an adhesive patch pattern 820. Each label 800 within the roll further includes an optional printed/imaged sense mark (not shown in FIG. 8), which is read by a printer when present to delineate and to identify each label 800 within the roll.

In an embodiment, the adhesive patch pattern 820 includes 3 adhesive patches, which do not intersect with one another on the backside 801 of each label 800. The adhesive patches are vertically striped down the backside 801 and are continuous throughout the roll. The patches do not intersect one another and are separated by vertical areas that are devoid of adhesive.

In an embodiment, the adhesive patch pattern 820 includes 2 adhesive patches, which do not intersect with one another on the backside 801 of each label 800 within the roll. The two adhesive patches are vertically striped down the backside 801 with each adhesive patch adjacent to a side of the backside 801 of the roll.

In an embodiment, the adhesive patch pattern 720 include a first adhesive patch offset, adjacent to, or extending to a side of the roll. A second adhesive patch of the pattern 720 is substantially centered on the backside 701 and is continuous on the roll. A third adhesive patch of the pattern 720 is offset, adjacent to, or extending to an opposite side of the roll from the first patch.

The coverage area, shape, size, orientation, and placement of the adhesive patches within the pattern 820 of the adhesive patches are optimized to minimize contact with printer components when the roll of the labels 800 are fed through the printer. However, the coverage area, shape, size, orientation, and placement of the adhesive patches within the pattern 820 of the adhesive patch for each dispensed label 800 from the printer maintains the adhesive bonding characteristics for the type of the adhesive used to still stick and adhered the label 800 to package materials, objects, and surfaces.

In an embodiment, a repositionable and microsphere adhesive is used for the adhesive patches identified by pattern 820. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 820 is between 30% and 70% of a total surface area of the backside of the label 800.

In an embodiment, a front side of the label 800 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 800 includes a stock weight of greater than or equal to 50 gsm.

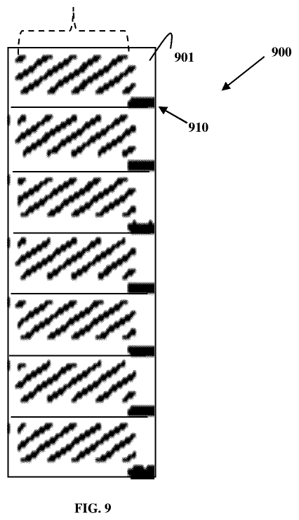

FIG. 9 is a diagram of linerless labels 900 in a roll, each label 900 includes an adhesive patch pattern 920, which is optimized for printer applications, according to an example embodiment. A backside 901 for each label 900 in the roll is illustrated in FIG. 9.

The backside 901 includes an adhesive patch illustrated by the darkened areas (except not 910), which are arranged in an adhesive patch pattern 920. Each label 900 within the roll further includes an optional printed/imaged sense mark 910, which is read by a printer to delineate and to identify each label 900 within the roll.

The adhesive patch pattern 920 includes 7 adhesive patches, which do not intersect with one another on the backside 901 of each label 900. Between each adhesive patch is an area, which is devoid of any adhesive. The adhesive patches are evenly spaced apart from one another along the backside 901 and diagonally disposed along the backside 901. The adhesive patches are offset from a top, a bottom, a right, and a left side of label 900. Each adhesive patch extends from a top right portion of the label to a bottom left portion of the label 900. Pairs of the adhesive patches are of a same size, whereas the sizes between different pairs are of varied sizes.

The coverage area, shape, size, orientation, and placement of the 7 adhesive patches within the pattern 920 of the adhesive patch are optimized to minimize contact with printer components when the roll of the labels 900 are fed through the printer. However, the coverage area, shape, size, orientation, and placement of the 7 adhesive patches within the pattern 920 of the adhesive patch for each dispensed label 900 from the printer maintains the adhesive bonding characteristics for the type of the adhesive used to still stick and adhered the label 900 to package materials, objects, and surfaces.

In an embodiment, a repositionable and microsphere adhesive is used for the adhesive patch identified by pattern 920. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 920 is between 30% and 70% of a total surface area of the backside of the label 900.

In an embodiment, a front side of the label 900 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 900 includes a stock weight of greater than or equal to 50 gsm.

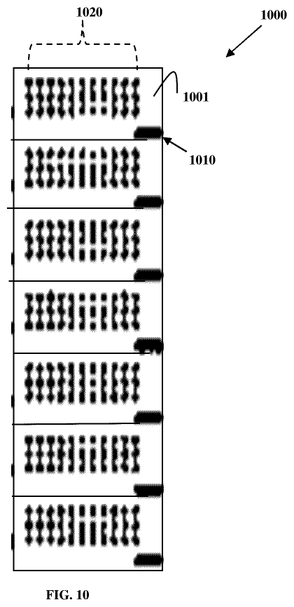

FIG. 10 is a diagram of yet another linerless label 1000 in a roll, each label 1000 includes an adhesive patch pattern 1020, which is optimized for printer applications, according to an example embodiment. A backside 1001 for each label 1000 in the roll is illustrated in FIG. 10.

The backside 1001 includes an adhesive patch illustrated by the darkened areas (except not 1010), which are arranged in an adhesive patch pattern 1020. Each label 1000 within the roll further includes an optional printed/imaged sense mark 1010, which is read by a printer to delineate and to identify each label 1000 within the roll.

The adhesive patch pattern 1020 includes three rows of adhesive patches, which do not intersect with one another on the backside 1001 of each label 1000. Between each adhesive patch is an area, which is devoid of any adhesive. The adhesive patches are evenly spaced apart from one another within their corresponding rows along the backside 1001. The adhesive patches are offset from a top, a bottom, a right, and a left side of label 1000. In an embodiment, each row includes 11 rectangle or bar shaped adhesive patches. In an embodiment, each row includes 5 or more rectangle or bar shaped adhesive patches, each bar shaped adhesive patch is areas on the backside 1001 that are adhesive free or devoid of any adhesive. In an embodiment, each row includes 8 or more rectangle or bar shaped adhesive patches, each bar shaped adhesive patch is areas on the backside 1001 that are adhesive free or devoid of any adhesive. A first row of the adhesive patches is adjacent to a top, right, and left side of the label 1000 and adjacent to a second row of the adhesive patches along a bottom. The second row of the adhesive patches is adjacent on a right to a right side of the label 1000, adjacent on a left to a left side of the label 1000, adjacent to the first row along a top, and adjacent to a third row of the adhesive patches along a bottom. The third row of adhesive patches is adjacent on a right to a right side of the label 1000, adjacent on a left to left side of the label 1000, adjacent to a bottom side of the label 1000 along a bottom, and adjacent along a top to a bottom of the second row of adhesive patches. Each adhesive patch extends from a top right portion of the label 1000 to a bottom left portion of the label 1000. Pairs of the adhesive patches are of a same size, whereas the sizes between different pairs are of varied sizes.

The coverage area, shape, size, orientation, and placement of the three rows adhesive patches within the pattern 1020 of the adhesive patch are optimized to minimize contact with printer components when the roll of the labels 1000 are fed through the printer. However, the coverage area, shape, size, orientation, and placement of the three rows of adhesive patches within the pattern 1020 of the adhesive patch for each dispensed label 1000 from the printer maintains the adhesive bonding characteristics for the type of the adhesive used to still stick and adhered the label 1000 to package materials, objects, and surfaces.

In an embodiment, a repositionable and microsphere adhesive is used for the adhesive patch identified by pattern 1020. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 1020 is between 30% and 70% of a total surface area of the backside of the label 1000.

In an embodiment, a front side of the label 1000 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 1000 includes a stock weight of greater than or equal to 50 gsm.

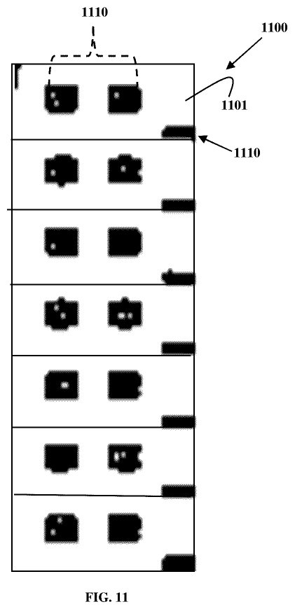

FIG. 11 is a diagram of linerless labels 1100 in a roll, each label 900 includes an adhesive patch pattern 1120, which is optimized for printer applications, according to an example embodiment. A backside 1101 for each label 1100 in the roll is illustrated in FIG. 11.

The backside 1101 includes an adhesive patch illustrated by the darkened areas (except not 1110), which are arranged in an adhesive patch pattern 1120. Each label 1100 within the roll optionally includes an optional printed/imaged sense mark 1110, which is read by a printer to delineate and to identify each label 1100 within the roll.

The adhesive patch pattern 1120 includes two adhesive patches, which do not intersect with one another on the backside 1101 of each label 1100. Between each adhesive patch is an area, which is devoid of any adhesive. In an embodiment, the two adhesive patches are square shaped. Each adhesive patch is equally spaced from a top, a bottom, and a left or right side of the label 1100. Furthermore, the two adhesive patches are equally spaced between one another, such that the two adhesive patches are substantially centered as a pair on the backside 1101.

The coverage area, shape, size, orientation, and placement of the two adhesive patches within the pattern 1120 of the adhesive patch are optimized to minimize contact with printer components when the roll of the labels 1100 are fed through the printer. However, the coverage area, shape, size, orientation, and placement of the two adhesive patches within the pattern 1120 of the adhesive patch for each dispensed label 1100 from the printer maintains the adhesive bonding characteristics for the type of the adhesive used to still stick and adhered the label 1100 to package materials, objects, and surfaces.

In an embodiment, the adhesive within a given adhesive patch is discontinuous. In an embodiment, the adhesive within a given adhesive patch is continuous. In an embodiment, the adhesive between the adhesive patches is discontinuous.

In an embodiment, a repositionable and microsphere adhesive is used for the adhesive patch identified by pattern 1120. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 1120 is between 30% and 70% of a total surface area of the backside of the label 1100.

In an embodiment, a front side of the label 1100 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 1100 includes a stock weight of greater than or equal to 50 gsm.

FIG. 12 is a diagram of a linerless label 1200 with an adhesive patch pattern 1220 optimized for printer applications, according to an example embodiment. The darkened areas depicted in FIG. 12 represent the diamond-shaped adhesive patches on backside 1201 of the label 1200. In an embodiment, a plurality of linerless labels 1200 are disposed on the backside 1201 of a roll. The non-darkened areas depicted in FIG. 12 represent areas devoid of any adhesive or void areas. As used herein “void areas” are areas that are adhesive free and devoid of any adhesive. Void areas are continuous along a periphery of the backside of label 1200.

The adhesive patches are arranged in a pattern 1220 on the backside 1201 of the label 1200. The pattern 1220 includes both adhesive areas and void areas having a diamond shape. The adhesive diamond shapes of the pattern 1220 include first diamond shapes of adhesive and second diamond shapes of adhesive. The first diamond shapes of adhesive are larger than and surround the second diamond shapes of adhesive. The second diamond shapes of adhesive are separated by outlined void and adhesive free diamond shaped areas, which are adjacent to the first diamond shapes of adhesive.

In an embodiment, the pattern 1220 includes three rows of the first diamond shapes of adhesive, two rows of the second diamond shapes of adhesive, and two rows of the outlined void and adhesive free diamond shaped areas.

In an embodiment, a repositionable and microsphere adhesive is used for the adhesive patches identified by pattern 1220. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 1220 is between 30% and 70% of a total surface area of the backside of the label 1200.

In an embodiment, a front side of the label 1200 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 1200 includes a stock weight of greater than or equal to 50 gsm.

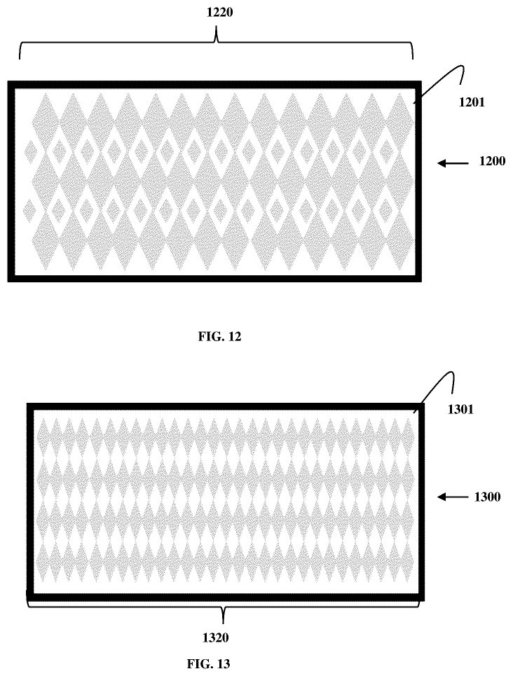

FIG. 13 is a diagram of a linerless label 1300 with an adhesive patch pattern 1320 optimized for printer applications, according to an example embodiment. The darkened areas depicted in FIG. 13 represent the diamond-shaped adhesive patches on backside 1301 of the label 1300. In an embodiment, a plurality of linerless labels 1300 are disposed on the backside 1301 of a roll. The non-darkened areas depicted in FIG. 13 represent areas devoid of any adhesive or void areas. Void areas are continuous along a periphery of the backside of label 1300.

The adhesive patches are arranged in a pattern 1320 on the backside 1301 of the label 1300. The pattern 1320 includes both adhesive areas and void areas having an elongated diamond shape. The elongated adhesive diamond shapes of the pattern 1320 include first diamond shapes of adhesive and second diamond shapes of adhesive. The density of the elongated diamond shapes of adhesive in label 1300 is greater than a density of the first and second diamond shapes of adhesive shown in label 1200 of FIG. 12.

In the pattern 1320, each elongated diamond-shaped adhesive patch intersects or touches at least two other elongated diamond-shaped adhesive patches. In an embodiment, there are 4 rows of elongated diamond-shaped adhesive patches in the pattern 1320 with three rows of diamond-shaped areas that are devoid of any adhesive.

In an embodiment, a repositionable and microsphere adhesive is used for the adhesive patches identified by pattern 1320. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 1320 is between 30% and 70% of a total surface area of the backside of the label 1300.

In an embodiment, a front side of the label 1300 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 1300 includes a stock weight of greater than or equal to 50 gsm.

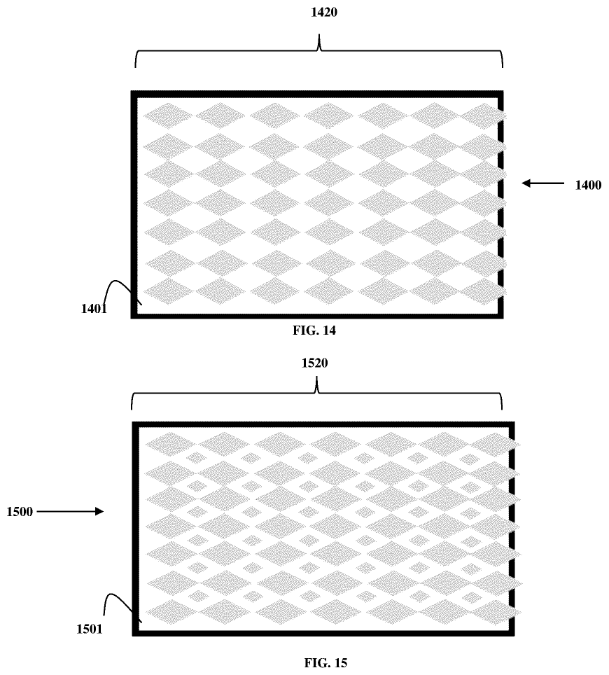

FIG. 14 is a diagram of a linerless label 1400 with an adhesive patch pattern optimized for printer applications, according to an example embodiment. The darkened areas depicted in FIG. 14 represent the diamond-shaped adhesive patches on backside 1401 of the label 1400. In an embodiment, a plurality of linerless labels 1400 are disposed on the backside 1401 of a roll. The non-darkened areas depicted in FIG. 14 represent areas devoid of any adhesive or void areas. Void areas are continuous along a periphery of the backside of label 1400.

The adhesive patches are arranged in a pattern 1420 on the backside 1401 of the label 1400. The pattern 1420 includes both adhesive areas and void areas having a diamond shape. The adhesive diamond shapes of the pattern 1420 are of a same size and shape. In between pairs of rows of the adhesive diamond shapes are void areas having diamond shapes.

In an embodiment, the pattern 1420 includes 7 rows of adhesive diamond shapes and 6 rows of the adhesive free and void areas having diamond shapes.

In an embodiment, a repositionable and microsphere adhesive is used for the adhesive patches identified by pattern 1420. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 1420 is between 30% and 70% of a total surface area of the backside of the label 1400.

In an embodiment, a front side of the label 1400 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 1400 includes a stock weight of greater than or equal to 50 gsm.

FIG. 15 is a diagram of a linerless label 1500 with an adhesive patch pattern 1520 optimized for printer applications, according to an example embodiment. The darkened areas depicted in FIG. 15 represent the diamond-shaped adhesive patches on backside 1501 of the label 1500. In an embodiment, a plurality of linerless labels 1500 are disposed on the backside 1501 of a roll. The non-darkened areas depicted in FIG. 15 represent areas devoid of any adhesive or void areas. Void areas are continuous along a periphery of the backside of label 1500.

The adhesive patches are arranged in a pattern 1520 on the backside 1501 of the label 1500. The pattern 1520 includes both adhesive areas and void areas having a diamond shape. The pattern includes first diamond shaped adhesive areas that are larger than second diamond shaped adhesive areas. Each second diamond shaped adhesive area is centered between 4 first diamond shaped adhesive areas. The first diamond shaped adhesive areas to not intersect any of the second diamond shaped adhesive areas. Moreover, each second diamond shaped adhesive area does not intersect with any of the remaining diamond shaped adhesive areas. Each second diamond shaped adhesive area is centered within a void and adhesive free diamond shaped area.

In an embodiment, the pattern 1520 includes 7 rows of the first and larger diamond shaped areas, 6 rows of the second and smaller diamond shaped areas, and 6 rows of the void and adhesive free diamond shaped areas.

In an embodiment, a repositionable and microsphere adhesive is used for the adhesive patches identified by pattern 1520. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 1520 is between 30% and 70% of a total surface area of the backside of the label 1500.

In an embodiment, a front side of the label 1500 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 1500 includes a stock weight of greater than or equal to 50 gsm.

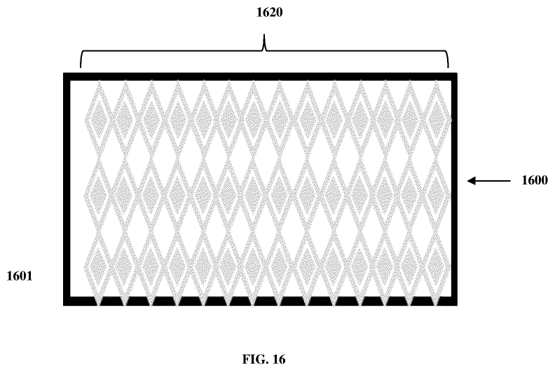

FIG. 16 is a diagram of a linerless label 1600 with an adhesive patch pattern 1620 optimized for printer applications, according to an example embodiment. The darkened areas depicted in FIG. 16 represent the diamond-shaped adhesive patches on backside 1601 of the label 1600. In an embodiment, a plurality of linerless labels 1600 are disposed on the backside 1601 of a roll. The non-darkened areas depicted in FIG. 16 represent areas devoid of any adhesive or void areas. Void areas are continuous along a periphery of the backside of label 1600.

The adhesive patches are arranged in a pattern 1620 on the backside 1601 of the label 1600. The pattern 1620 includes both adhesive areas and void or adhesive free areas having an elongated diamond shape. The pattern includes first elongated diamond shaped adhesive areas that surround a void and adhesive free elongated diamond shaped area, which surrounds second elongated diamond shaped adhesive areas. Each first elongated diamond shaped adhesive area outlines and surrounds a corresponding void and adhesive free elongated diamond shaped area. Each void and adhesive free elongated diamond shaped area outlines and surrounds a corresponding second elongated diamond shaped area. Each first elongated diamond shaped adhesive area intersects with 2 to 4 other first elongated diamond shaped adhesive areas. The first elongated diamond shaped areas do not interest with any of the second elongated diamond shaped areas.

In an embodiment, there are three rows of first elongated diamond shaped adhesive areas that surround corresponding void and adhesive free elongated diamond shaped areas, which surround corresponding second elongated diamond shaped areas. There are two rows of larger void and adhesive free elongated diamond shaped areas.

In an embodiment, a repositionable and microsphere adhesive is used for the adhesive patches identified by pattern 1620. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 1620 is between 30% and 70% of a total surface area of the backside of the label 1600.

In an embodiment, a front side of the label 1600 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 1600 includes a stock weight of greater than or equal to 50 gsm.

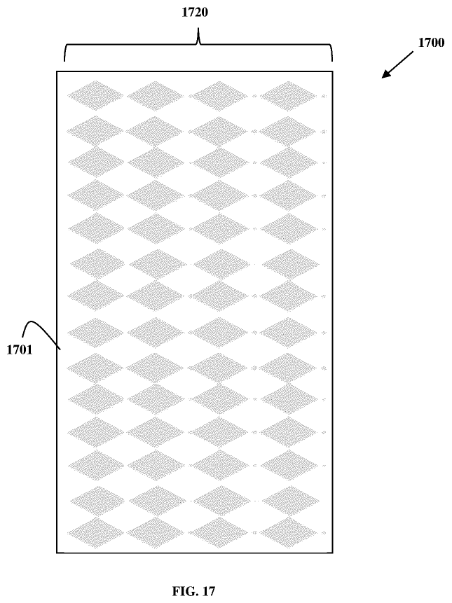

FIG. 17 is a diagram of linerless labels 1700 in a roll with an adhesive patch pattern 1720 optimized for printer applications, according to an example embodiment. A backside 1701 for each label 1700 in the roll is illustrated in FIG. 17.

The backside 1701 includes adhesive patches illustrated by the darkened areas, which are arranged in an adhesive patch pattern 1720. Each label 1700 within the roll optionally includes an optional printed/imaged sense mark (not shown in FIG. 17), which is read by a printer to delineate and to identify each label 1700 within the roll.

The adhesive patch pattern 1720 includes rows of diamond shaped adhesive areas/patches, which do not intersect with one another on the backside 1701 of each label 1700 defined with the roll. Between each set of 4 diamond shaped adhesive patches is an area, which is devoid of any adhesive; the void and adhesive free area is also in a diamond shape.

In an embodiment, the diamond shaped adhesive patches are vertically striped down the backside 1701 of the roll in columns. In an embodiment, the backside 1701 of the roll includes 4 or more columns of the diamond shaped adhesive patches. In an embodiment, the backside 1702 of the roll includes 5 or more columns of the diamond shaped adhesive patches.

In an embodiment, a repositionable and microsphere adhesive is used for the adhesive patches identified by pattern 1720. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 1720 is between 30% and 70% of a total surface area of the backside of the label 1700.

In an embodiment, a front side of the label 1700 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 1700 includes a stock weight of greater than or equal to 50 gsm.

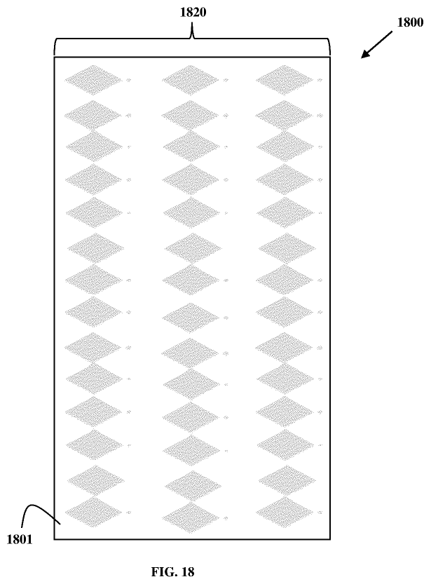

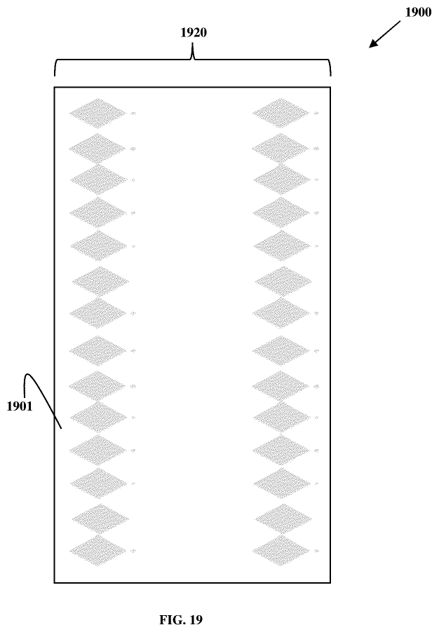

FIG. 18 is a diagram of linerless labels 1800 of a roll with an adhesive patch pattern 1820 optimized for printer applications, according to an example embodiment. A backside 1801 for each label 1800 in the roll is illustrated in FIG. 18.

The backside 1801 includes adhesive patches illustrated by the darkened areas, which are arranged in an adhesive patch pattern 1820. Each label 1800 within the roll optionally includes an optional printed/imaged sense mark (not shown in FIG. 18), which is read by a printer to delineate and to identify each label 1800 within the roll.

The adhesive patch pattern 1820 includes rows of diamond shaped adhesive areas/patches, which do not intersect with one another on the backside 1801 of each label 1800 defined with the roll. Between each diamond shaped adhesive patch is an area, which is devoid of any adhesive. Each diamond shaped adhesive patch is discontinuous from remaining diamond shaped adhesive patches on the backside 1801 of the roll.

In an embodiment, the diamond shaped adhesive patches are vertically striped down the backside 1801 of the roll in columns. In an embodiment, the backside 1801 of the roll includes 3 columns of the diamond shaped adhesive patches.

In an embodiment, a repositionable and microsphere adhesive is used for the adhesive patches identified by pattern 1820. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 1820 is between 30% and 70% of a total surface area of the backside of the label 1800.

In an embodiment, a front side of the label 1800 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 1800 includes a stock weight of greater than or equal to 50 gsm.

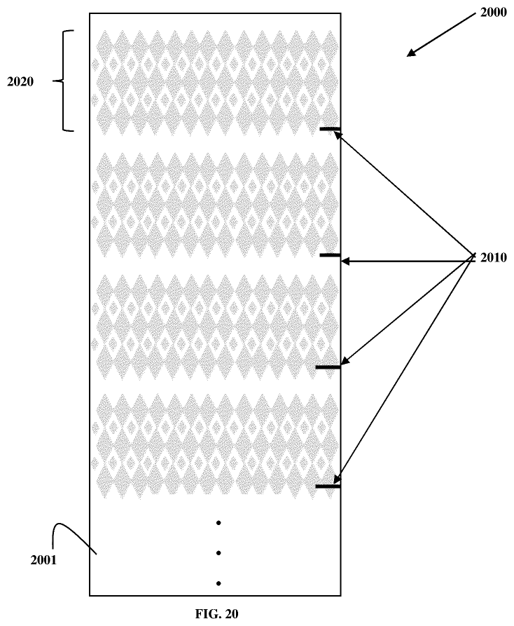

FIG. 19 is a diagram of linerless labels 1900 of a roll with an adhesive patch pattern 1920 optimized for printer applications, according to an example embodiment. A backside 1901 for each label 1900 in the roll is illustrated in FIG. 19.

The backside 1901 includes adhesive patches illustrated by the darkened areas, which are arranged in an adhesive patch pattern 1920. Each label 1900 within the roll optionally includes an optional printed/imaged sense mark (not shown in FIG. 19), which is read by a printer to delineate and to identify each label 1900 within the roll.

The adhesive patch pattern 1920 includes two rows of diamond shaped adhesive areas/patches, which do not intersect, and which are discontinuous with one another on the backside 1901 of each label 1900 defined with the roll. Remaining areas of the backside 1901 are areas that a void and free of any adhesive.

In an embodiment, the diamond shaped adhesive patches are vertically striped down the backside 1901 of the roll in 2 columns. Each column of the diamond shaped adhesive patches is adjacent to a side of the roll.

In an embodiment, a repositionable and microsphere adhesive is used for the adhesive patches identified by pattern 1820. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 1920 is between 30% and 70% of a total surface area of the backside of the label 1900.

In an embodiment, a front side of the label 1900 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 1900 includes a stock weight of greater than or equal to 50 gsm.

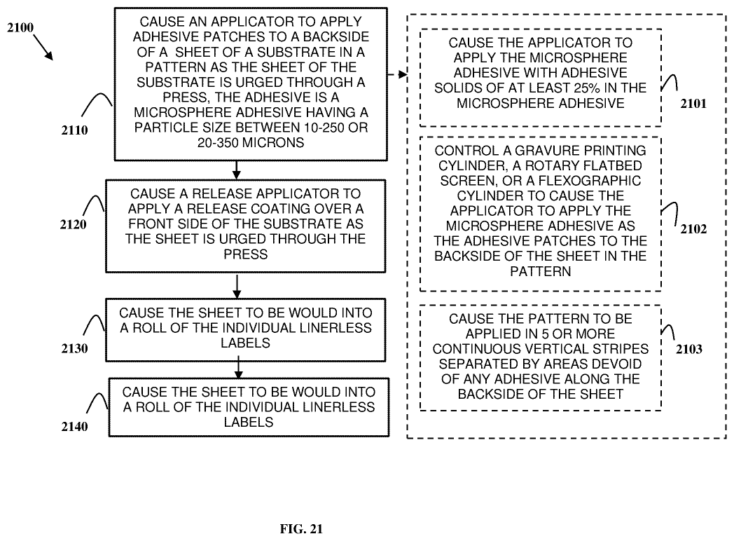

FIG. 20 is a diagram of linerless labels 2000 of a roll with an adhesive patch pattern 2020 optimized for printer applications, according to an example embodiment. A backside 2001 for each label 2000 in the roll is illustrated in FIG. 20.

The backside 2001 includes adhesive patches illustrated by the darkened areas, which are arranged in an adhesive patch pattern 2020. Each label 2000 within the roll optionally includes a printed/imaged sense mark, which is read by a printer to delineate and to identify each label 1900 within the roll.

The adhesive patch pattern 2020 is the patch pattern 1220 discussed with FIG. 12 above.

In an embodiment, the diamond shaped adhesive patches are vertically striped down the backside 1901 of the roll in 2 columns. Each column of the diamond shaped adhesive patches is adjacent to a side of the roll. Each pattern 202 of adhesive patches end with a sense mark 2010 and are separated by a continuous void area that is devoid of an adhesive. The sense marks 2010 are detectable and read by a printer causing the printer to advance the roll into the continuous void area and cut an individual label 2000 from the roll. This ensures that no adhesive material contacts a cutting mechanism of the printer.

In an embodiment, a repositionable and microsphere adhesive is used for the adhesive patches identified by pattern 2020. In an embodiment, the repositionable and microsphere adhesive includes microspheres of adhesive having a particle size approximately between 10-250 microns. In an embodiment, the repositionable and microsphere adhesive includes solid materials that make up at least 25% of the repositionable and microsphere adhesive. In an embodiment, the repositionable and microsphere adhesive is an acrylic emulsion that includes adhesive microspheres in a solid range of at least 25% and particle size of approximately 20-350 microns.

In an embodiment, the coverage surface area of the adhesive patch pattern 2020 is between 30% and 70% of a total surface area of the backside of a given label 2000.

In an embodiment, a front side of the label 2000 includes a thermally activated print or image coating. In an embodiment, a release coating is disposed atop the thermally activated print or image coating. In an embodiment, the release coating is a water-based release coating. In an embodiment, the release coating is a non-silicone release coating. In an embodiment, the release coating is a silicone-based release coating.

In an embodiment, the label substrate of the label 2000 includes a stock weight of greater than or equal to 50 gsm.

FIG. 21 is a diagram of a method 2100 for manufacturing a roll of linerless labels, each label with an adhesive patch pattern optimized for printer applications, according to an example embodiment. The method 2100 is implemented on a press through firmware that controls electro-mechanical components of the press to manufacture linerless labels 100, 200, 300, 400, 500, 600, 700, 800, 900, 1000, 1100, 1200, 1300, 1400, 1500, 1600, 1700, 1800, 1900, and/or 2000 on rolls, as described herein and above. A processor associated with the firmware/software executes instructions to perform the method 2100 and to control the electromechanical components of the press.

The press includes a variety of stations. Each station associated with manufacturing a specific component of the linerless labels 100, 200, 300, 400, 500, 600, 700, 800, 900, 1000, 1100, 1200, 1300, 1400, 1500, 1600, 1700, 1800, 1900, and/or 2000. The roll includes a web of a label substrate that passes through the stations and is wound into a roll of the labels. Each roll includes a plurality of instances of linerless labels defined within the corresponding roll. The processor executes the instructions of the firmware/software to cause the corresponding electromechanical components of a given station to add the corresponding specific component to the labels to the roll.

The specific components added to the labels at the stations include, by way of example only, applying an acrylic emulsion adhesive as microsphere adhesive having a solids ranges of at least 25% and a microsphere particle size of 10-250 or 20-350 microns in optimized patch patterns 120, 220, 320, 420, 520, 620, 720, 820, 920, 1020, 1120, 1320, 1420, 1520, 1620, 1720, 1820, 1920, 2020 to a backside of the substrate; applying a release coating to a front side of the substrate; applying a thermally activated print coating to the backside and/or front side of the substrate when the thermally activated print coating was not already present on the substrate; drying one or any of the coatings applied to the backside and/or front side of the substrate; cooling or curing one or any of the coatings applied to the backside and/or front side of the substrate; optionally printing sense marks when the sense marks were not already pre-printed on the label substrate and when sense marks are desired; a cutting the web into sheets rolling the sheets into rolls; etc.

An adhesive application station includes a variety of electromechanical components controlled by the processor via the corresponding instructions of the firmware/software. The electromechanical components include an applicator controlled by the processor to apply an adhesive patch in any of the above-noted adhesive patch patterns 120, 220, 320, 420, 520, 620, 720, 820, 920, 1020, 1120, 1220, 1320, 1420, 1520, 1620, 1720, 1820, 1920, and/or 2020.

In an embodiment, the electromechanical components of the applicator include a single hot melt module, or a plurality of hot melt modules arranged in an array or a grid. In an embodiment, the electromechanical components of the applicator include a stamp wheel, or a plurality of stamp wheels arranged in a single line or a plurality of lines. In an embodiment, the electromechanical components of the applicator include a single gravure printing cylinder and/or a single rotary flatbed screen and/or a single flexographic cylinder. In an embodiment, the electromechanical components of the applicator include a plurality of gravure printing cylinders and/or plurality of rotary flatbed screens and/or a plurality of flexographic cylinders arranged in a plurality of rows.

At 2110, the processor of the press causes the applicator to apply acrylic emulsion microsphere adhesive patches in an adhesive pattern 120, 220, 320, 420, 520, 620, 720, 820, 920, 1020, 1120, 1220, 1320, 1420, 1520, 1620, 1720, 1820, 1920, and/or 2020 on a backside of a sheet of a label substrate as the sheet of the substrate is being urged through the press. The microsphere adhesive includes microsphere adhesive particle sizes of between 10-250 or 20-350 microns. The adhesive pattern of the patch is optimized to minimize the adhesive coverage area of the patch and to ensure or to minimize adhesive contact with components of a printer.

In an embodiment, at 2101, the processor of the press causes the applicator to apply the microsphere adhesive with adhesive solids of at least 25% in the microsphere adhesive.

In an embodiment, at 2102, the processor of the press controls the applicator to apply the microsphere adhesive as the adhesive patches using a gravure printing cylinder, a rotary flatbed screen, or a flexographic cylinder.

In an embodiment, at 2103, the processor of the press causes the pattern to be applied in 4 or more continuous vertical stripes separated by areas devoid of any adhesive along the backside of the sheet.

The adhesive patch is applied via an applicator or a corresponding station of the press (e.g., hot melt module, hot melt modules arranged in an array or a grid, a stamp wheel, a plurality of stamp wheels arranged in a single line or a plurality of lines, a single gravure printing cylinder, a single rotary flatbed screen, a single flexographic cylinder, a plurality of gravure printing cylinders, a plurality of rotary flatbed screens, and/or a plurality of flexographic cylinders arranged in a plurality of rows).

At 2120, the processor of the press causes a release applicator to apply a release coating over a front side of the label substrate as the sheet is urged through the stations of the press. In an embodiment, at 2121, the press causes a release applicator to apply a non-silicone based release coating, a water-based release coating, or a silicon-based release coating.

At 2130, the processor of the press causes the sheet to be would into a roll. In an embodiment, the processor causes the sheet to be cut into two or more sheets and thereafter causes each individual sheet to be wound into a roll. In an embodiment, the roll or the individual rolls are linerless label rolls, each roll includes a plurality of linerless labels defined within the corresponding roll by the sense marks and each linerless label include a single adhesive patch with the adhesive disposed on the corresponding backside in the optimized pattern 120, 220, 320, 420, 520, 620, 720, 820, 920, 1020, 1120, 1320, 1420, 1520, 1620, 1720, 1820, 1920, and/or 2020.

Although the present invention is described with reference to certain preferred embodiments thereof, variations and modifications of the present invention can be affected within the spirit and scope of the following claims.

1. A roll of linerless labels, comprising:
a substrate; and
an adhesive patch disposed on a backside of the substrate, wherein the adhesive patch disposed in a pattern of an adhesive on the backside, wherein the pattern repeats along the backside, and wherein the adhesive is a microsphere adhesive with a particle size of between 10-250 or 20-350 microns, wherein the pattern enables a consistent and continuous contact with a platen roller of a printer as the platen roller advances the label media through the printer to ensure consistent pull and energy exerted by the printer as the label media proceeds through a printer web path;
wherein the pattern minimizes adhesive buildup on components of the printer when the roll of labels is fed through the printer without decreasing adhesive bonding characteristics of labels dispensed from the printer.

2. The roll of claim 1, wherein the microsphere adhesive includes solids of at least 25%.

3. The roll of claim 1 further comprising, a release coating applied atop a thermal print coating on a front side of the substrate, wherein the release coating comprises a water-based release coating, a silicone-based release coating, or a non-silicone based release coating.

4. The roll of claim 1, wherein the pattern includes 5 or more continuous stripes of the microsphere adhesive, each stripe separated by an area devoid of any adhesive.

5. The roll of claim 1, wherein the substrate comprises a stock weight of greater than or equal to 50 gsm (grams per square meter).

6. The roll of claim 1, wherein a coverage area of the microsphere adhesive within the pattern is between 30% and 70% of a total surface area of the backside that corresponds to any given label defined within the roll.

7. The roll of claim 1, wherein the pattern includes diamond shaped adhesive areas and diamond shaped void areas that are devoid of any adhesive.

8. The roll of claim 1, wherein the microsphere adhesive is an acrylic emulsion comprising microspheres in a solids range of at least 25%.

9. The roll of claim 1, wherein the adhesive patch comprises two adhesive patches vertically striped down the backside of the substrate, wherein a first adhesive patch is vertically striped adjacent to a first side of the backside of the substrate and a second adhesive patch is vertically striped adjacent to a second side of the backside of the substrate.

10. The roll of claim 1, wherein each label within the roll is repositionable based on the microsphere adhesive on a corresponding backside of a corresponding label.

11. The roll of claim 1, wherein the particle size is 10-250 microns, the microsphere adhesive is an acrylic emulsion with a solids ranges of greater than 25% and the substrate comprises a stock weight of more than 50 gsm (grams per square meter).

12. The roll of claim 1 further comprising:
a thermally activated print coating on a front side of the substrate; and
a release coating disposed atop the thermally activated print coating.

13. A linerless label, comprising:
a substrate; and
at least one adhesive patch disposed on a backside in a pattern, wherein the adhesive patch comprises an acrylic emulsion including microspheres with a solids ranges of at least 25% and a microsphere particle size of between 10-250 or 20-350 microns;
a thermally activated print coating disposed on a front side of the substrate;
a release coating disposed atop or over the thermally activated print coating;
wherein the pattern minimizes a coverage area of the acrylic emulsion along the backside of the substrate associated with the at least one adhesive patch and minimizes adhesive contact with components of a printer when the linerless label is fed through the printer;
wherein the adhesive patch enables a cutting mechanism of the printer to cut through the label substrate cleanly while minimizing adhesive debris on the cutting mechanism;
wherein the pattern and adhesive formulation provide characteristics for sufficient high tack and aggressive adhesives while mitigating printer adhesive buildup, jams and other printer malfunctions caused by adhesive buildup on printer components.

14. The label of claim 13, wherein the coverage area is between 30% and 70% of a total surface area of the backside of the linerless label.

15. The label of claim 14, wherein the substrate comprises a stock weight of greater than 50 gsm (grams per square meter).

16. The label of claim 15, wherein the at least one adhesive patch comprises a first adhesive patch and a second adhesive patch vertically striped along a first side and a second side of the backside of the substrate.

17.-20. (canceled)
